(19) United States
(12) Patent Application Publication
(10) Pub. No.: US 2026/0016542 A1
(43) Pub. Date: Jan. 15, 2026

(54) INFORMATION PROCESSING DEVICE, INFORMATION PROCESSING METHOD, AND PROGRAM

(71) Applicant: GS Yuasa International Ltd., Kyoto-shi, Kyoto (JP)

(72) Inventors: Shuhei SATO, Kyoto-shi, Kyoto (JP); Nan UKUMORI, Kyoto-shi, Kyoto (JP)

(21) Appl. No.: 18/992,080

(22) PCT Filed: Jun. 21, 2023
(86) PCT No.: PCT/JP2023/022951

§ 371 Date: Jan. 7, 2025

(30) Foreign Application Priority Data
Jul. 12, 2022 (JP) 2022-111732

(51) Int. Cl. G01R 31/382; G01R 31/36; G06F 18/10; G06F 123/02

(52) U.S. Cl. CPC G01R 31/382; G01R 31/3648; G06F 18/10; G06F 2123/02

(57) ABSTRACT

An information processing device includes an acquisition unit that acquires time-series data including a current value of a first energy storage device detected by a first detection device, and a correction unit that corrects the acquired time-series data based on a correlation between the time-series data acquired by the acquisition unit and reference time-series data including a current value of a second energy storage device detected by a second detection device.

### CROSS REFERENCE TO RELATED APPLICATIONS

This application is a National Stage Application, filed under 35 U.S.C. § 371, of International Application No. PCT/JP2023/022951, filed Jun. 21, 2023, which international application claims priority to and the benefit of Japanese Application No. 2022-111732, filed Jul. 12, 2022; the contents of both of which are hereby incorporated by reference in their entirety.

### BACKGROUND

### Technical Field

The present application generally relates to an information processing device, an energy storage device, an information processing method, and a program.

### Description of Related Art

As a method of estimating behavior of an energy storage device, a method of estimating behavior of an energy storage device such as a state of charge (SOC) by applying a Kalman filter to an equivalent circuit model in which the energy storage device is represented by an electric circuit is known (see, for example, JP-A-2016-065828).

### BRIEF SUMMARY

An equivalent circuit model is constructed so as to simulate voltage behavior when current is actually applied to an experimental energy storage device. Detection data of current, voltage, and the like detected by an experimental device is used to construct the equivalent circuit model. On the other hand, when actual behavior of an energy storage device is estimated using the constructed equivalent circuit model, detection data of current, voltage, and the like detected by a detection device included in the energy storage device is used. In a case where detection devices included in an energy storage device and an experimental device have different sensor accuracy, an error occurs between obtained detection data, and behavior of the energy storage device cannot be accurately estimated by an equivalent circuit model. Such a viewpoint is not considered in the conventional technique described in JP-A-2016-065828.

An object of the present disclosure is to provide an information processing device and the like capable of acquiring data in consideration of an error between data in an energy storage device detected by a first detection device and reference data detected by a second detection device.

An information processing device according to one aspect of the present disclosure includes an acquisition unit that acquires time-series data including a current value of a first energy storage device detected by a first detection device, and a correction unit that corrects the acquired time-series data based on a correlation between the time-series data acquired by the acquisition unit and reference time-series data including a current value of a second energy storage device detected by a second detection device.

According to the present disclosure, it is possible to acquire data in consideration of an error between data in an energy storage device detected by the first detection device and reference data detected by the second detection device.

### BRIEF DESCRIPTION OF THE FIGURES

FIG. 1 is a schematic diagram illustrating a configuration example of an energy storage device on which an information processing device according to the present embodiment is mounted.

FIG. 2 is a block diagram illustrating an internal configuration of the information processing device.

FIG. 3 is a functional block diagram illustrating a configuration example of the information processing device.

FIG. 4 is a diagram illustrating an example of current data.

FIG. 5 is a diagram illustrating an example of voltage data.

FIG. 6 is a diagram illustrating an example of SOC fluctuation amount data.

FIG. 7 is a flowchart illustrating an example of a processing procedure executed by the information processing device.

FIG. 8 is a diagram illustrating an effect of a method of the present embodiment.

### DETAILED DESCRIPTION OF VARIOUS EMBODIMENTS

Data used for constructing an equivalent circuit model is acquired by measuring current, voltage, temperature, and the like in an experimental energy storage device by using an experimental device. Usually, a highly accurate sensor device is used in an experimental device, and relatively highly accurate data is detected. With data obtained with high accuracy, it is possible to construct an equivalent circuit model that accurately simulates behavior of an energy storage device. In an actual energy storage device, for example, current, voltage, temperature, and the like are detected by a detection device mounted on the energy storage device. In such a detection device, for example, due to a difference in accuracy of the detection device itself, influence of noise, and the like, data with lower accuracy than that detected by an experimental device is detected in many cases.

In a case where data in an actual energy storage device having a deviation from data detected by an experimental device is applied as it is to an equivalent circuit model constructed using the data detected by the experimental device, an actual state of the energy storage device is not reflected, and an estimation result with low accuracy is obtained. At the time of estimation by an equivalent circuit model, it is necessary to consider an error generated between actual data detected in an energy storage device and data detected in an experimental device.

Since a current value of an actual energy storage device cannot be calibrated during operation of an actual energy storage device, it is necessary to appropriately correct the current value to be closer to a current value of an experimental energy storage device detected by an experimental device in order to accurately estimate a state based on time-series data of the current value. The present inventors have found that a correlation is established between data in an actual energy storage device and data in a test device. Then, the inventors have an idea that the above error can be eliminated by using this correlation.

(1) An information processing device according to one aspect of the present disclosure includes an acquisition unit that acquires time-series data including a current value of a first energy storage device detected by a first detection device, and a correction unit that corrects the acquired time-series data based on a correlation between the time-series data acquired by the acquisition unit and reference time-series data including a current value of a second energy storage device detected by a second detection device.

Here, the first detection device may be a detection device included in the first energy storage device. The first energy storage device is an energy storage device as a target of estimation, and means an energy storage device that is actually in use or scheduled to be used.

The second detection device is a detection device that detects a state of the second energy storage device, and may be, for example, the above-described experimental device. The second energy storage device may be, for example, the experimental energy storage device described above.

The first energy storage device and the second energy storage device may be the same energy storage device or different energy storage devices.

The reference time-series data of the second energy storage device detected by the second detection device means one that is intended to be widely used for various types of processing related to generation of estimation reference or an estimating means for estimating a state of the first energy storage device. The reference time-series data may be, for example, one that is intended for constructing an equivalent circuit model.

Hereinafter, time-series data including a current value of the first energy storage device detected by the first detection device is also referred to as pre-correction data. Reference time-series data including a current value of the second energy storage device detected by the second detection device is also referred to as reference data.

According to the above configuration, pre-correction data can be corrected (calibrated) so as to eliminate an error occurring between pre-correction data and reference data. By applying the obtained data after correction to the estimating means or the estimation reference generated based on reference time-series data, estimation accuracy can be improved. For example, by applying data after correction to an equivalent circuit model, it is possible to accurately estimate capacity reflecting an actual state of the first energy storage device.

(2) In the information processing device according to (1) above, the correlation may be expressed by a correlation function indicating a relationship between a current value in the time-series data and a current value in the reference time-series data.

According to the information processing device according to (2) above, it is easy to perform correction processing of pre-correction data based on a correlation defined as a correlation.

(3) In the information processing device according to (2) above, the correlation function may be a linear function.

According to the information processing device according to (3) above, calculation cost of correction processing of pre-correction data based on a correlation can be reduced.

(4) In the information processing device according to any one of (1) to (3) above, the correction unit may correct the time-series data so that a current value in the time-series data related to an idle period of the first energy storage device becomes closer to a current value in the reference time-series data related to an idle period of the second energy storage device.

The idle period is a period in which charge and discharge of an energy storage device are not performed, and means a period corresponding to a rest state. In a case where charge and discharge are not performed, no current flows in and out of an energy storage device, so that a current value does not change originally. Therefore, a current value in reference data with high sensor accuracy is substantially zero. On the other hand, in pre-correction data, a minute current value is detected even during an idle period. This minute current value is continuously detected not only in an idle period but also in another period. The minute current value causes an error between reference data and pre-correction data.

According to the information processing device according to (4) above, pre-correction data in an idle period is corrected so as to approximate a current value of reference data in the idle period, that is, zero. By the above, minute current in pre-correction data can be removed. By using data in an idle period in which only minute current to be removed is generated and analysis of a minute current value is easy, correction can be performed with high accuracy.

(5) The information processing device according to any one of (1) to (4) above may further include a setting unit that sets definition information indicating a relationship between the time-series data and the reference time-series data, and the correction unit may correct the time-series data according to the correlation including the definition information set by the setting unit.

According to the information processing device according to (5) above, the definition information indicating a relationship between pre-correction data and reference data can be appropriately set at the time of correction. The relationship between pre-correction data and reference data means a correlation between the pre-correction data and the reference data. For example, a change in a state of the first energy storage device, such as environmental temperature or the number of years of operation of the first energy storage device, can be appropriately reflected in a correlation, and correction accuracy of pre-correction data can be improved.

(6) In the information processing device according to (5) above, the time-series data may include a voltage value of the first energy storage device. The information processing device may further include an identification unit that identifies an idle period of the first energy storage device based on a voltage value in the time-series data, and the setting unit may set the definition information based on the time-series data related to the idle period of the first energy storage device identified by the identification unit.

During the above-described idle period, a voltage value does not change regardless of sensor accuracy. Therefore, according to the information processing device according to (6) above, the identification unit can easily and reliably identify an idle period in pre-correction data by focusing on a voltage value of the pre-correction data. The setting unit can easily and appropriately set definition information based on a current characteristic of pre-correction data and reference data in the idle period described above.

(7) In the information processing device according to (6) above, the setting unit may calculate time-series data of an energy storage amount based on the time-series data, and set the definition information so as to minimize a difference between an energy storage amount at a first time point in the idle period of the first energy storage device and an energy storage amount at a second time point before the first time point based on the calculated time-series data of the energy storage amount.

The energy storage amount means an amount of energy stored in the first energy storage device, and may be, for example, a state of charge (SOC) of the first energy storage device or a total amount of electricity.

According to the information processing device according to (7) above, the definition information is set such that a change amount of an energy storage amount in pre-correction data of an idle period becomes closer to a change amount of an energy storage amount in reference data of the idle period, that is, becomes closer to zero. By optimizing the definition information, a correlation indicating a good correlation between reference data and pre-correction data can be obtained.

(8) In the information processing device according to (6) or (7) above, the identification unit may identify, as the idle period, a period in which a change amount of a voltage value is less than a predetermined value for predetermined time or more in a plurality of the first energy storage devices connected to a same series circuit.

According to the information processing device according to (8) above, by considering a voltage value in a plurality of the first energy storage devices, it is possible to prevent erroneous identification of an idle period due to, for example, failure or malfunction of a detection device in a single one of the first energy storage devices. Therefore, identification accuracy of an idle period can be improved.

(9) The information processing device according to any one of (1) to (8) above may further include an estimation unit that estimates capacity of the first energy storage device by applying the time-series data after correction to an estimation model constructed using the reference time-series data.

The estimation model may be, for example, an equivalent circuit model. According to the information processing device according to (9) above, accuracy of capacity estimation by the estimation model can be improved by applying data after correction.

(10) An energy storage device according to one aspect of the present disclosure includes the information processing device according to any one of (1) to (8) above.

(11) An information processing method according to one aspect of the present disclosure causes a computer to execute processing of acquiring time-series data including a current value of a first energy storage device detected by a first detection device, and correcting the acquired time-series data based on a correlation between the time-series data and reference time-series data including a current value of a second energy storage device detected by a second detection device.

(12) A program according to one aspect of the present disclosure causes a computer to execute processing of acquiring time-series data including a current value of a first energy storage device detected by a first detection device, and correcting the acquired time-series data based on a correlation between the time-series data and reference time-series data including a current value of a second energy storage device detected by a second detection device.

Hereinafter, the present disclosure will be specifically described with reference to the drawings illustrating an embodiment of the present disclosure.

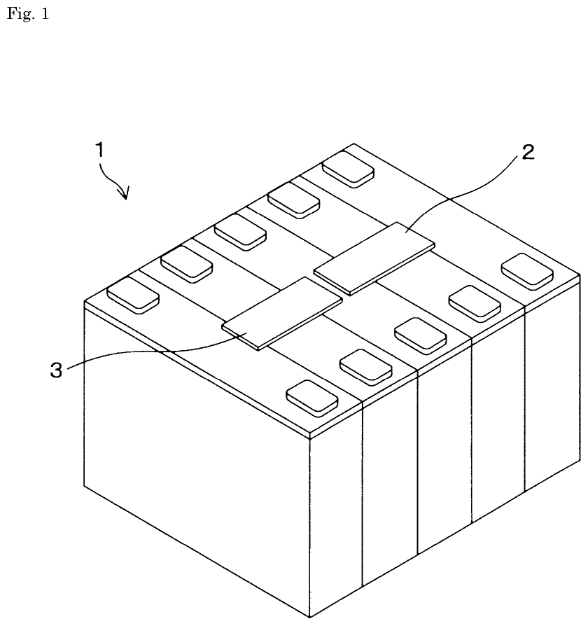

FIG. 1 is a schematic diagram illustrating a configuration example of an energy storage device 1 on which an information processing device 3 according to the present embodiment is mounted. The energy storage device 1 is, for example, a lithium ion battery in which electrolyte is liquid. Alternatively, the energy storage device 1 may be an optional battery such as a laminate type (pouch type) lithium ion battery, a lithium ion battery in which electrolyte is ionic liquid, a lithium ion battery in which electrolyte is gel, an all-solid lithium ion battery, a bipolar type lithium ion battery (battery in which electrodes are electrically connected in series), a zinc-air battery, a sodium ion battery, or a lead-acid battery. The energy storage device 1 may be a single cell, a module in which a plurality of cells are connected in series and/or in parallel, a bank in which a plurality of modules are connected in series, a domain in which a plurality of banks are connected in parallel, or the like.

The energy storage device 1 is applied to, for example, a power source for storing renewable energy or power generated by an existing power generating system. Alternatively, the energy storage device 1 may be applied to an uninterruptible power system, a DC or AC power supply device included in a stabilized power supply, a power supply for electronic equipment, a power supply for an automobile, and the like.

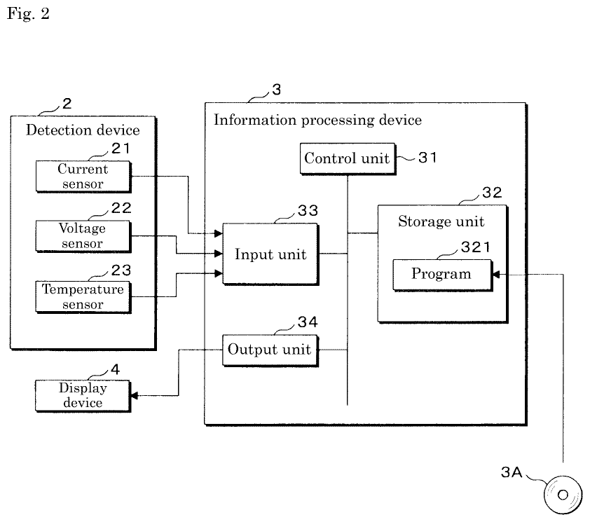

The energy storage device 1 includes a detection device 2 and an information processing device 3 which are flat circuit boards. The detection device 2 includes a current sensor 21, a voltage sensor 22, and a temperature sensor 23 (see FIG. 2). The current sensor 21 detects current flowing through the energy storage device 1. The voltage sensor 22 detects inter-terminal voltage of the energy storage device 1. The temperature sensor 23 detects temperature of the energy storage device 1.

The information processing device 3 acquires time-series data including data related to current, data related to voltage, and data related to temperature of the energy storage device 1 by acquiring each detection value detected by the detection device 2 as needed. Time-series data of current, voltage, and temperature of the energy storage device 1 detected by the detection device 2 corresponds to pre-correction data. The information processing device 3 generates corrected data suitable for input to an equivalent circuit model by performing correction processing to be described later on the obtained pre-correction data.

FIG. 1 shows an example in which the detection device 2 and the information processing device 3 are installed on an upper surface of the energy storage device 1. Alternatively, an installation location may be a side surface of the energy storage device 1 or a lower surface of the energy storage device 1. The information processing device 3 may be installed separately from the energy storage device 1. A shape of the detection device 2 and the information processing device 3 is not limited to a flat plate shape. The information processing device 3 may be provided in a battery management unit (BMU) or may be provided in a server device installed at a remote location. In the latter case, a detection value detected for the energy storage device 1 is preferably transmitted to the server device by communication.

FIG. 2 is a block diagram describing an internal configuration of the information processing device 3. The information processing device 3 includes, for example, a control unit 31, a storage unit 32, an input unit 33, and an output unit 34.

The control unit 31 is an arithmetic circuit including a central processing unit (CPU), a read only memory (ROM), a random access memory (RAM), and the like. The CPU included in the control unit 31 executes various computer programs stored in the ROM or the storage unit 32 and controls operation of each hardware unit described above, so as to cause the entire device to function as the information processing device of the present disclosure. The control unit 31 may have a function of a timer that measures elapsed time from when a measurement start instruction is given to when a measurement end instruction is given, a counter that counts the number, a clock that outputs date and time information, and the like.

The storage unit 32 includes a non-volatile storage device such as a flash memory. The storage unit 32 stores a program and data referred to by the control unit 31. A program stored in the storage unit 32 includes a program 321 for causing a computer to execute processing related to generation of corrected data.

The storage unit 32 stores a correlation between pre-correction data and reference data, an estimation model for capacity estimation, and the like as data used for execution of the program 321. In the present embodiment, the correlation is a linear function, and the storage unit 32 stores a formula indicating the linear function, a formula for calculating a parameter in the linear function, and the like.

A computer program (program product) including the program 321 may be provided by a non-transitory recording medium 3A in which the computer program is readably recorded. The recording medium 3A is a portable memory such as a CD-ROM, a USB memory, or a secure digital (SD) card. The control unit 31 reads a desired computer program from the recording medium 3A by using a reading device (not illustrated), and stores the read computer program in the storage unit 32. Alternatively, the computer program may be provided by communication. The program 321 may include a single computer program or a plurality of computer programs, and may be executed on a single computer or may be executed on a plurality of computers interconnected by a communication network.

The input unit 33 includes an interface for connecting the detection device 2. The control unit 31 acquires a current value detected by the current sensor 21, a voltage value detected by the voltage sensor 22, and temperature detected by the temperature sensor 23 as needed through the input unit 33.

The output unit 34 includes an interface for connecting a display device 4. In an example of the display device 4, in a case where an estimation result including the corrected data described above, capacity estimated using the corrected data, or the like is obtained, the control unit 31 which is a liquid crystal display device outputs information based on the obtained estimation result from the output unit 34 to the display device 4. The display device 4 displays an estimation result based on information output from the output unit 34.

Alternatively, the output unit 34 may include a communication interface that communicates with an external device. An external device communicatively connected to the output unit 34 is a terminal device such as a personal computer or a smartphone used by the user, an administrator, or the like. In a case where the estimation result is obtained, the control unit 31 transmits information based on the estimation result from the output unit 34 to the terminal device. The terminal device receives the information transmitted from the output unit 34, and displays the estimation result on a display of the terminal device based on the received information. Alternatively, the terminal device may perform another control or prediction and estimation by using the estimation result.

Corrected data generated by the information processing device 3 will be described. Time-series data (pre-correction data) of current, voltage, and temperature of the energy storage device 1 detected by the detection device 2 is input to, for example, an equivalent circuit model and used for capacity estimation of the energy storage device 1. On the other hand, as described above, an equivalent circuit model is constructed using time-series data (reference data) of current, voltage, and temperature of an experimental energy storage device detected by a detection device in an experimental device. In order to improve estimation accuracy by an equivalent circuit model, it is necessary to correct pre-correction data having lower sensor accuracy than reference data and to generate true data from which an error due to a difference in sensor accuracy is removed.

According to knowledge of the present inventors, when a correlation between a current value I_{mod} in pre-correction data and a current value I_{cdm} in reference data is functionalized, a linear function represented by Formula (1) below is established.

$${I}_{cdm} = a \times {I}_{mod} + b \qquad ( 1 )$$

A parameter a and a parameter b in Formula (3) are parameters that may change according to a state of the energy storage device 1. The parameter a and the parameter b are set each time corrected data is generated. Details of a method of setting the parameter a and the parameter b will be described later.

By correcting the current value I_{mod} using Formula (1) above, it is possible to generate true data in which an error included in the current value I_{mod} is eliminated, that is, corrected data.

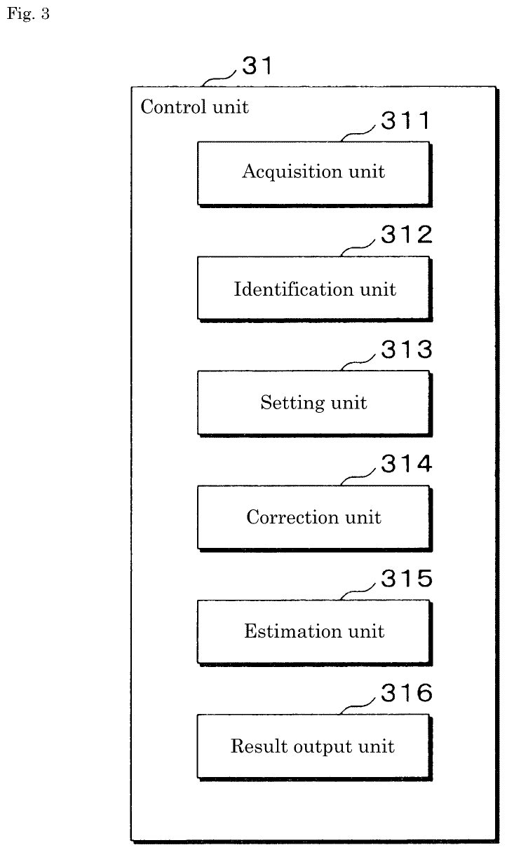

FIG. 3 is a functional block diagram illustrating a configuration example of the information processing device 3. The control unit 31 of the information processing device 3 functions as an acquisition unit 311, an identification unit 312, a setting unit 313, a correction unit 314, an estimation unit 315, and a result output unit 316 by reading and executing the program 321 stored in the storage unit 32.

The acquisition unit 311 acquires time-series data of a current value, a voltage value, and temperature of the energy storage device 1 by receiving detection values detected by the detection device 2 in time-series order via the input unit 33. The time-series data acquired by the acquisition unit 311 corresponds to pre-correction data.

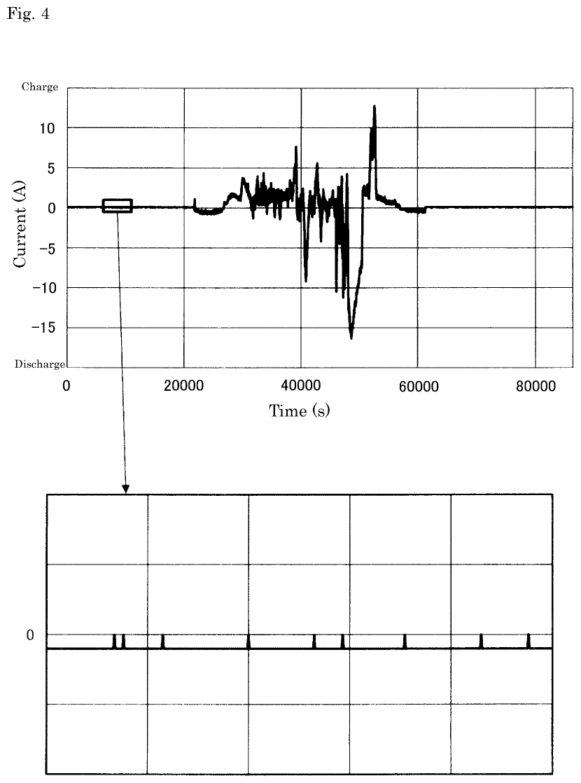

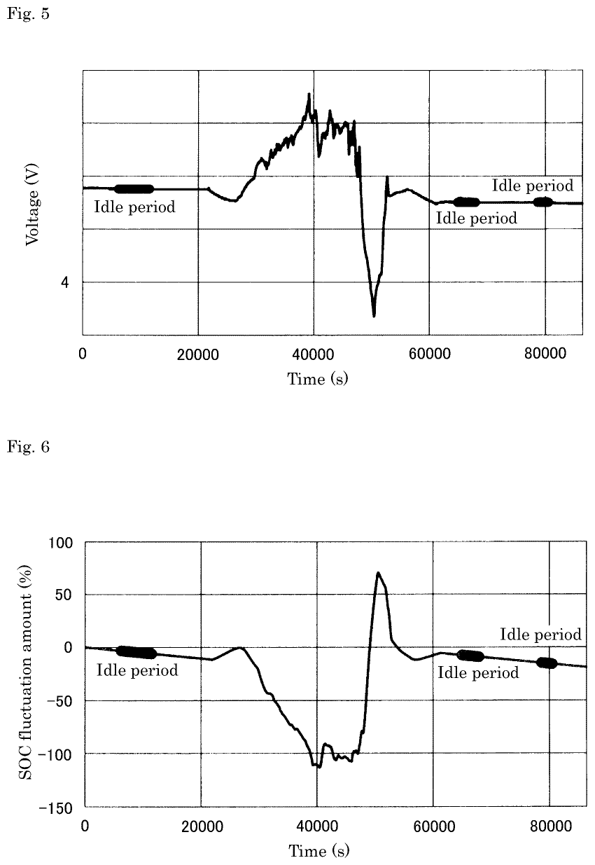

FIG. 4 is a diagram illustrating an example of current data, and FIG. 5 is a diagram illustrating an example of voltage data. The horizontal axis of a graph illustrated in FIG. 4 represents time(s), and the vertical axis represents current (A). The positive side of the vertical axis represents charge, and the negative side represents discharge. The acquisition unit 311 acquires time-series current data as illustrated in FIG. 4. The horizontal axis of a graph illustrated in FIG. 5 represents time(s), and the vertical axis represents voltage (V). The acquisition unit 311 acquires time-series voltage data as illustrated in FIG. 5.

Here, a graph illustrated on the lower side of FIG. 4 is an enlarged rectangular region in a graph illustrated on the upper side of FIG. 4. As illustrated on the lower side of FIG. 4, a minute current value is detected even in a period in which charge and discharge are not performed in the energy storage device 1. In reference data having higher accuracy than pre-correction data, such a minute current value is hardly detected in a period in which charge and discharge are not performed. The information processing device 3 generates corrected data corresponding to sensor accuracy equivalent to reference data by removing the above-described minute current value in pre-correction data by correction processing to be described later.

Further, the acquisition unit 311 calculates time-series data of an energy storage amount based on acquired time-series data of current. Hereinafter, a case where an SOC is calculated as an energy storage amount will be described as an example.

The SOC can be obtained by current integration, and can be calculated by, for example, Formula (2) below.

$$\begin{matrix}[ Mathematical formula 1 ] & \\ {SOC}_{i} = {SOC}_{i - 1} + \frac{1}{FCC} {\int }_{{t}_{i - 1}}^{{t}_{i}} {I}_{i} dt & ( 2 )\end{matrix}$$

In Formula (2), SOCᵢ is a current SOC, SOCᵢ₋₁ is a previous SOC, FCC is a full discharge capacity, and I is a current value.

The acquisition unit 311 further calculates time-series data of an SOC fluctuation amount. The SOC fluctuation amount is obtained by subtracting SOCᵢ₋₁ from SOCᵢ.

FIG. 6 is a diagram illustrating an example of SOC fluctuation amount data. The horizontal axis of a graph illustrated in FIG. 6 represents time(s), and the vertical axis represents an SOC fluctuation amount (%). The acquisition unit 311 acquires time-series SOC fluctuation amount data as illustrated in FIG. 6.

In the above description, an SOC is calculated as an energy storage amount. Alternatively, an energy storage amount may be a total amount of electricity. In this case, the acquisition unit 311 may calculate time-series data of a total amount of electricity with a total amount of electricity at an initial point of time as zero. The time-series data acquired by the acquisition unit 311 is output to the identification unit 312, the setting unit 313, and the correction unit 314.

The identification unit 312 identifies an idle period in the energy storage device 1 based on time-series data of voltage acquired by the acquisition unit 311. For example, the identification unit 312 may identify a period in which a change amount of a voltage value is less than a predetermined value (for example, 0.001 (V)) for predetermined time (for example, 3600 seconds) or more as the idle period, but the idle period is not limited to this. In a case where a non-use time zone of the energy storage device 1 is known, a period of the non-use time zone may be set in advance as the idle period.

The identification unit 312 extracts an idle time point satisfying the above condition from among detection time points included in a period to be determined, and identifies a period including the extracted idle time point as an idle period. In the graphs of FIGS. 5 and 6, a black circle indicates idle time points. Information indicating an idle period identified by the identification unit 312 is output to the setting unit 313.

In a case where a plurality of the energy storage devices 1 are provided close to each other, an idle period may be identified based on a voltage value in a plurality of the energy storage devices 1 connected to the same series circuit. The identification unit 312 preferably extracts a period which is identified as an idle period in common in at least two or more of the energy storage devices 1 including the energy storage device 1 to be corrected.

Based on an idle period identified by the identification unit 312 and pre-correction data acquired by the acquisition unit 311, the setting unit 313 sets (optimizes) the parameter a and the parameter b in Formula (3) above so as to remove a current value detected during the idle period.

Specifically, the parameter a and the parameter b are optimized so as to minimize a sum ε expressed by Formula (3) below. The setting unit 313 may optimize the parameter a and the parameter b by using, for example, a method such as a genetic algorithm or a gradient method, but the configuration is not limited to this.

$$\begin{matrix}[ Mathematical formula 2 ] & \\ ε = {\sum }_{i = 1}^{n} Δ {SOC}_{i} = \frac{1}{FCC} {\sum }_{i = 1}^{n} Δ {Q}_{i} = \frac{1}{FCC} {\sum }_{i = 1}^{n} {\int }_{{t}_{i - 1}}^{{t}_{i}} {I}_{i}^{′} dt = \frac{1}{FCC} {\sum }_{i = 1}^{n} {\int }_{{t}_{i - 1}}^{{t}_{i}} ( a \times {I}_{i} + b ) dt & ( 3 )\end{matrix}$$

In Formula (3), ΔSOCi is an absolute value of a difference between an SOC fluctuation amount at an idle time point and an SOC fluctuation amount at a time point immediately before the idle time point (in the past). ΔQi is an absolute value of a difference between a total amount of electricity at an idle time point and a total amount of electricity at a time point immediately before the idle time point. FCC is full discharge capacity. I′ is a current value after correction, and I is a current value before correction.

Based on time-series data of an SOC fluctuation amount acquired by the acquisition unit 311, the setting unit 313 calculates, for each idle time point included in an idle period, an absolute value (ΔSOCi) of a difference between the SOC fluctuation amount at an idle time point and an SOC fluctuation amount at a time point immediately before the idle time point. The setting unit 313 obtains the parameter a and the parameter b that minimize the sum ε of the calculated absolute values ΔSOCi of differences at idle time points. The parameter a and the parameter b with which the sum ε is minimized are set as parameters to be used for generation of corrected data.

Note that in a case where a total amount of electricity is used as an energy storage amount, the setting unit 313 may optimize the parameter a and the parameter b so as to minimize the sum of the absolute values ΔQi of differences between the total amounts of electricity. The parameter a and the parameter b set by the setting unit 313 are output to the correction unit 314. According to the above processing, the parameter a and the parameter b are set so that a current value in pre-correction data related to an idle period becomes closer to a current value in reference data related to the idle period, that is, zero.

The correction unit 314 substitutes the parameter a and the parameter b received from the setting unit 313 and a current value in pre-correction data received from the acquisition unit 311 into Formula (1) described above, executes arithmetic processing of Formula (1), and calculates a current value as corrected data. By sequentially executing calculation on each current value in pre-correction data, corrected data including time-series current data from which an error is removed is obtained. Corrected data generated by the correction unit 314 is output to the estimation unit 315. The corrected data may be output to an output unit.

The estimation unit 315 estimates battery capacity of the energy storage device 1 by inputting corrected data received from the correction unit 314 to an equivalent circuit model. Alternatively, an estimation model may be a model for estimating an SOC of the energy storage device 1, a model for estimating charge-discharge characteristics, a life prediction model, or the like. The estimation unit 315 applies corrected data to an estimation model to estimate a state of the energy storage device 1. Battery capacity estimated by the estimation unit 315 is output to the result output unit 316.

The result output unit 316 outputs an estimation result indicating battery capacity received from the estimation unit 315 to the display device 4 via the output unit 34. The result output unit 316 may output corrected data received from the correction unit 314 as an estimation result.

The above correction processing may be performed using time-series data in an entire period from a start time point at which acquisition of time-series data in the energy storage device 1 is started to a current time point (correction processing time point). The correction processing may be performed using time-series data in a period from a reference time point set after the start time point to a current time point. That is, a period of time-series data to be corrected may be the entire period or a predetermined period (for example, half a year, one year, or the like).

In the above description, an example in which setting of the parameter a and the parameter b is executed using data at all idle time points included in the idle period in time-series data to be corrected described above. Alternatively, the parameter a and the parameter b may be set using only data at an idle time point satisfying a predetermined condition among pieces of data at the idle time point. Examples of a predetermined condition include a condition in which temperature at an idle time point is within a preset temperature range, a condition in which an idle time point is within past three months from a current point, and the like.

In the above description, a correlation between pre-correction data and reference data is defined by a linear function including two parameters. Alternatively, a correlation may be defined by another functional expression such as a quadratic function or a polynomial, or may be defined by a function other than a functional expression. Further, the function system can be optionally selected and changed according to accuracy and tendency of the current sensor 21 or the detection device 2 in the energy storage device 1.

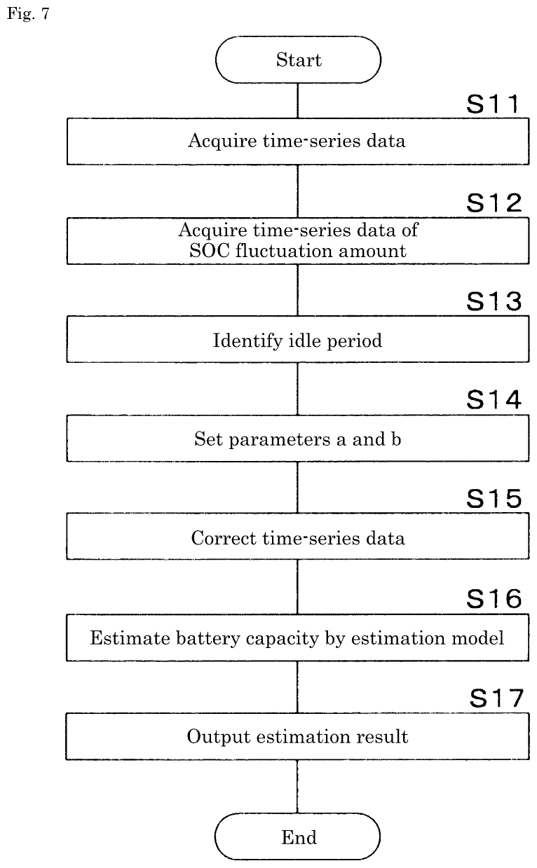

FIG. 7 is a flowchart illustrating an example of a processing procedure executed by the information processing device 3. Processing in each flowchart below may be executed by the control unit 31 according to the program 321 stored in the storage unit 32 of the information processing device 3, may be realized by a dedicated hardware circuit (for example, FPGA or ASIC) provided in the control unit 31, or may be realized by a combination of these.

The control unit 31 of the information processing device 3 acquires time-series data (pre-correction data) of a current value, a voltage value, and temperature of the energy storage device 1 detected by the detection device 2 (Step S11). The control unit 31 calculates time-series data of an SOC by current integration based on the acquired current value in the pre-correction data, and acquires time-series data of an SOC fluctuation amount based on the calculated time-series data of an SOC (Step S12).

The control unit 31 identifies an idle period in the energy storage device 1 based on a voltage value in the acquired pre-correction data (Step S13). For example, the control unit 31 may extract a time point at which a change amount of a voltage value in the pre-correction data is less than a predetermined value as a time point corresponding to an idle period for predetermined time or more.

In Step S13, the control unit 31 may identify an idle period based on a voltage value in a plurality of the energy storage devices 1. In a case where a predetermined condition is set in identifying an idle period, the control unit 31 may identify an idle period including only an idle time point satisfying the predetermined condition.

The control unit 31 sets the parameter a and the parameter b based on pre-correction data related to the identified idle period (Step S14). The control unit 31 optimizes the parameter a and the parameter b so as to minimize an amount of electricity generated by a minute current value in pre-correction data related to the idle period. Specifically, the control unit 31 optimizes the parameter a and the parameter b by, for example, a method such as a genetic algorithm or a gradient method so as to minimize the sum ε expressed by Formula (3) described above.

Using the set parameter a and parameter b, the control unit 31 corrects a current value in time-series data acquired in Step S11 according to a correlation function represented by Formula (1) above (Step S15). The control unit 31 acquires time-series data (corrected data) including the corrected current value. The control unit 31 calculates a corrected current value by substituting the parameter a, the parameter b, and the current value in the pre-correction data into Formula (1) described above.

The control unit 31 inputs the acquired corrected data to an estimation model to estimate a state of the energy storage device 1, for example, battery capacity (Step S16). The control unit 31 outputs an estimation result including the estimated battery capacity, the corrected data, and the like to the display device 4 (Step S17), and ends the series of processing.

According to the present embodiment, an error occurring between different pieces of detection data can be eliminated, and one piece of detection data can be calibrated to become closer to another piece of detection data serving as reference.

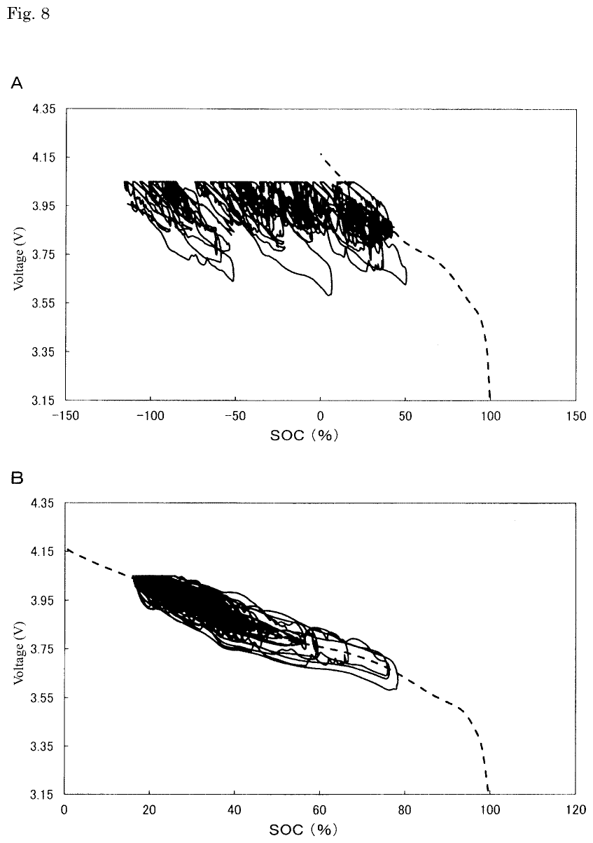

FIG. 8 is a diagram illustrating an effect of the method of the present embodiment. FIG. 8A shows a graph of an estimation result of charge-discharge characteristics in a case of using current data (pre-correction data) that is not corrected by the method of the present embodiment. FIG. 8B shows a graph of an estimation result of charge-discharge characteristics in a case of using current data (corrected data) that is corrected by the method of the present embodiment. In the graphs illustrated in FIGS. 8A and 8B, the horizontal axis represents SOC (%), and the vertical axis represents voltage (V). A solid line in the graphs illustrated in FIGS. 8A and 8B indicates an actual estimation result, and a broken line indicates an SOC-voltage curve generated from an estimation result.

In a case where current data is not corrected, a value of an SOC in the charge-discharge characteristics transitions in a range of about-100% to about 50%, which is an estimation result of movement in a charge direction. In a case where current data is corrected, an SOC transitions within a more appropriate SOC value range as compared with the case where the current data is not corrected. By using corrected data by the method of the present embodiment, it is possible to improve estimation accuracy of capacity.

It is to be understood that the embodiment disclosed herein is illustrative in all respects and not restrictive. The technical features described in examples can be combined with each other, and the scope of the present invention is intended to include all modifications within the claims and the scope equivalent to the claims.

A sequence described in each embodiment is not limited, and processing procedures may be executed in changed order within a range in which there is no contradiction, and a plurality of pieces of processing may be executed in parallel. A processing subject of each piece of processing is not limited, and processing of each device may be executed by another device within a range in which there is no contradiction.

Matters described in each embodiment can be combined with each other. Further, independent claims and dependent claims described in the claims can be combined with each other in all combinations regardless of the form of citation. Furthermore, a form (multi-claim form) in which claims referring to two or more other claims are described is used in the claims, but the present invention is not limited to this. The claims may be described using a form in which a multiple claim referring to at least one multiple claim (multiple dependent claim) is described.

1. An information processing device comprising:
an acquisition unit that acquires time-series data including a current value of a first energy storage device detected by a first detection device; and
a correction unit that corrects the acquired time-series data based on a correlation between the time-series data acquired by the acquisition unit and reference time-series data including a current value of a second energy storage device detected by a second detection device.

2. The information processing device according to claim 1, wherein the correlation is expressed by a correlation function indicating a relationship between a current value in the time-series data and a current value in the reference time-series data.

3. The information processing device according to claim 2, wherein the correlation function is a linear function.

4. The information processing device according to claim 1, wherein the correction unit corrects the time-series data so that a current value in the time-series data related to an idle period of the first energy storage device becomes closer to a current value in the reference time-series data related to an idle period of the second energy storage device.

5. The information processing device according to claim 1, further comprising a setting unit that sets definition information indicating a relationship between the time-series data and the reference time-series data, wherein the correction unit corrects the time-series data according to the correlation including the definition information set by the setting unit.

6. The information processing device according to claim 5, wherein
the time-series data includes a voltage value of the first energy storage device,
the information processing device further comprises an identification unit that identifies an idle period of the first energy storage device based on a voltage value in the time-series data, and
the setting unit sets the definition information based on the time-series data related to the idle period of the first energy storage device identified by the identification unit.

7. The information processing device according to claim 6, wherein
the setting unit
calculates time-series data of an energy storage amount based on the time-series data, and
sets the definition information so as to minimize a difference between an energy storage amount at a first time point in the idle period of the first energy storage device and an energy storage amount at a second time point before the first time point based on the calculated time-series data of the energy storage amount.

8. The information processing device according to claim 6, wherein the identification unit identifies, as the idle period, a period in which a change amount of a voltage value is less than a predetermined value for predetermined time or more in a plurality of the first energy storage devices connected to a same series circuit.

9. The information processing device according to claim 1, further comprising an estimation unit that estimates capacity of the first energy storage device by applying the time-series data after correction to an estimation model constructed using the reference time-series data.

10. An energy storage device comprising the information processing device according to claim 1.

11. An information processing method for causing a computer to execute processing of:
acquiring time-series data including a current value of a first energy storage device detected by a first detection device; and
correcting the acquired time-series data based on a correlation between the time-series data and reference time-series data including a current value of a second energy storage device detected by a second detection device.

12. A program for causing a computer to execute processing of:
acquiring time-series data including a current value of a first energy storage device detected by a first detection device; and
correcting the acquired time-series data based on a correlation between the time-series data and reference time-series data including a current value of a second energy storage device detected by a second detection device.
